(19) United States
(12) Patent Application Publication
(10) Pub. No.: US 2004/0178692 A1
(43) Pub. Date: Sep. 16, 2004

(54) METHODS AND APPARATUS FOR PROTECTIVELY COATING A STATOR FOR AN ELECTRIC MOTOR

(75) Inventor: Kamron Mark Wright, Fort Wayne, IN (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(73) Assignee: GENERAL ELECTRIC COMPANY, Schenectady, NY

(21) Appl. No.: 10/249,036

(22) Filed: Mar. 11, 2003

(51) Int. Cl. H02K 1/00; H02K 15/12; H02K 1/12

(52) U.S. Cl. 310/216; 310/45; 310/254

(57) ABSTRACT

A method of providing a protective coating on a stator for an electronically commutated motor includes providing at least one stator lamination including a bore, an inner edge, an outer edge, and an intermediate area extending between the inner edge and the outer edge. The method further includes forming a protective outer coating on the outer edge thereon.

### BACKGROUND OF INVENTION

This invention relates generally to electric motors and, more particularly, to methods and apparatus for coating a stator for an electric motor.

Electric motors are used in many different applications. Typically, the rotational force and torque generated within the motor is delivered by a rotor shaft. The torque generated is the product of current applied to the motor and an electromagnetic field maintained about the stator.

An electronically commutated motor (ECM) typically includes a motor housing, a stator mounted to the housing, and a rotor shaft rotatably mounted within a bore of the stator. A rotor core is mounted on the rotor shaft and includes a plurality of rotor windings. The stator includes a stator core including a plurality of electrically excitable windings. The stator windings generate a plurality of magnetic fields that oppose magnetic fields from the commutated windings on the rotor. For the rotor to turn, the windings on the stator reverse polarity through commutation. A brushless commutator placed on one end of the rotor provides a signal to the stator windings to reverse polarity. In at least some known ECMs, a shell is manufactured by rolled and welded steel to surround and protect the motor from the environment. However, eliminating the shell would reduce manufacturing processes and lower an overall motor cost.

### SUMMARY OF INVENTION

In one aspect, a method of providing a protective coating on a stator for an electronically commutated motor includes providing at least one stator lamination including a bore, an inner edge, an outer edge, and an intermediate area extending between the inner edge and the outer edge. The method further includes forming a protective outer coating on the outer edge thereon.

In another aspect, a stator for use in an electronically commutated motor is provided. The stator comprises at least one stator lamination including a bore, an inner edge, an outer edge, and an intermediate area extending between the inner edge and the outer edge. The outer edge further includes a protective outer coating thereon.

In a further aspect, an electronically commutated motor assembly is provided. The stator comprising a plurality of stacked laminations wherein each lamination includes an inner edge, an outer edge, and an intermediate area extending between the inner edge and the outer edge. The stacked laminations form a substantially continuous stator body including a first end, a second end, an inner surface, and an outer surface.

The inner surface forms a bore extending through the stator body. The outer surface further includes a protective outer coating thereon. A first end shield includes a bearing support having a bearing therein. The first end shield is coupled to the first stator body end. A second end shield includes a bearing support having a bearing therein. The second end shield is coupled to the second stator body end. The electric motor further comprises a rotor assembly positioned within the stator bore. The rotor assembly has a rotor shaft extending through the first and second end shields and is rotatably supported by the bearings.

### BRIEF DESCRIPTION OF DRAWINGS

FIG. 1 is an exploded perspective view of a motor.

FIG. 2 is an enlarged top view of a laminate element.

### DETAILED DESCRIPTION

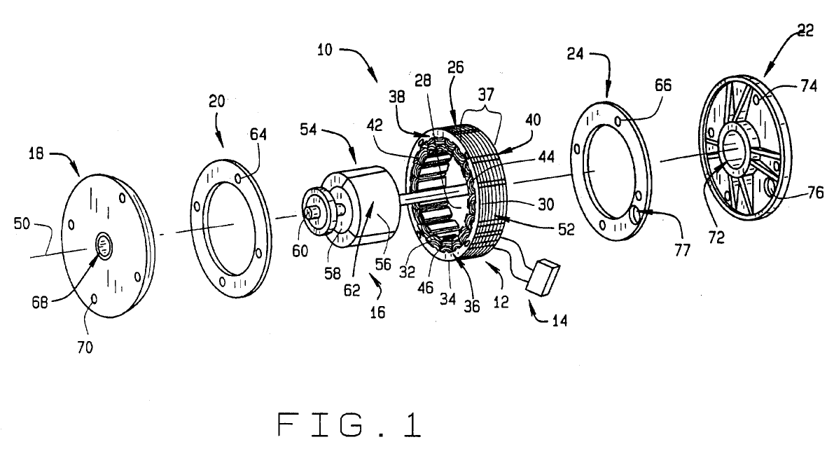

FIG. 1 is an exploded perspective view of a motor 10 including a stator assembly 12 with a harness assembly 14, and a rotor assembly 16. Motor 10 includes a first end shield 18, a first end cap 20, a second end shield 22, and a second end cap 24. In one embodiment, motor 10 is an electronically commutated motor for use in heating, ventilation, and air conditioning (HVAC) systems such as a GE 39 Frame (NEMA 48 frame) motor commercially available from General Electric Company, Plainville, Conn., and modified as herein described.

Stator assembly 12 and rotor assembly 16 are positioned between first and second end shields 22, 18. Stator assembly 12 includes a stator core 26 with a stator bore 28 extending therethrough. Stator core 26 is fabricated from at least one stator lamination 30, wherein stator lamination 30 has an inner edge 32, an outer edge 34, and an intermediate area 36 extending between inner edge 32, and outer edge 34. In one embodiment, stator core 26 includes a plurality of stacked stator laminations 30.

Outer edges 34 of stator laminations 30 are aligned to form a substantially continuous stator body 37 having first and second ends 38 and 40. Inner edges 32 of stator laminations 30 are aligned to form stator bore 28. Inner edges 32 of stator laminations 30 have a plurality of slots 42 that extend radially outwardly from stator bore 28.

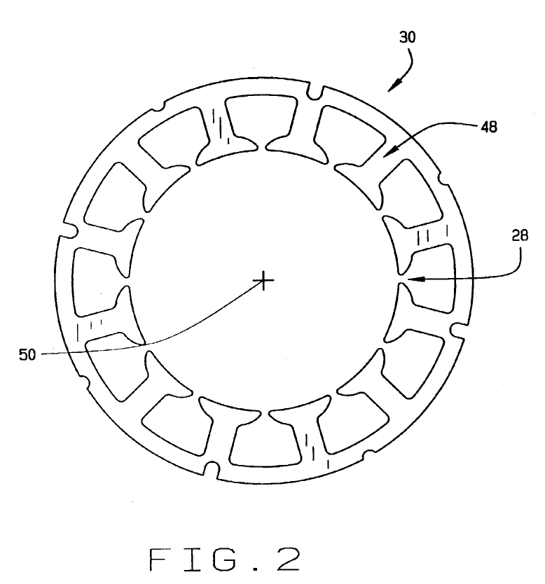

Stator core 26 provides support for a plurality of stator coils 44 formed from insulated conductive wire inserted into slots 42. Coils 44 form end turn regions 46 positioned at first and second stator ends 38 and 40 of stator body 37. FIG. 2 is an enlarged top view of a stator lamination 30. Specifically, stator bore 28 is formed by punching a center of a lamination 48 from each stator lamination 30 and the subsequent stacking of the stator laminations 30. In an exemplar embodiment, stator bore 28 is substantially cylindrical about a central axis 50.

Traditional motors are pressed into a protective steel shell surrounding the motor to withstand the environment. Outer edge 34 of at least one stator lamination 30 includes an protective outer coating 52 thereon. Protective outer coating 52 is formed on outer edge 34 by either varnish dipping or applying outer coating 52 by painting or other coating processes. In one embodiment, the protective outer coating 52 is formed on substantially continuous stator body 37.

Rotor assembly 16, such as a ECM rotor 16, is positioned within stator bore 28 and includes a rotor core 54, a plurality of pole sections 56, a rotor mounting assembly 58, a rotor shaft 60, and an outer rotor surface 62. Rotor shaft 60 is substantially concentric about axis 50 and rotor shaft 60 axially extends through rotor mounting assembly 58. Rotor mounting assembly 58 supports magnetic elements 56.

First end cap 20 is spaced between first end 38 of stator body 37 and first end shield 18 and has at least one fastener hole 64. First end cap 20 is coupled to first end 38 of stator body 37 and first end shield 18. Second end cap 24 is spaced between the second end 40 of stator body 37 and second end shield 22 and has at least one fastener hole 66. Second end cap 24 is coupled to second end 40 of stator body 37 and second end shield 22. First and second end caps 20 and 24 create an electrically insulating barrier between first end shield 18 and first stator body end 38 and between second end shield 22 and second stator body end 40, respectively. In one embodiment, first and second end caps 20 and 24 are made of an electrically insulating material, such as plastic.

First end shield 18 has a shaft hole 68 and at least one fastener hole 70 therethrough. Second end shield 22 may have a shaft hole 72 and at least one fastener hole 74 therethrough. In one embodiment, first and second end shields 18 and 22 have a bearing support (not shown) with a bearing (shown on the end of the shaft facing endshield 18) therein. Thus, when rotor assembly 16 is mounted within stator bore 28, rotor shaft 60 extends through first and second end shields 18 and 22 and is rotatably supported by bearings.

In another embodiment, second end shield 22 has a post hole 76 allowing harness connector 14 to interface with a control (not shown). In another embodiment, first and second end shields 18 and 22 are cast aluminum. In a further embodiment, first and second end shields 18 and 22 are made of an electrically insulating material, such as plastic, thereby eliminating the need for first and second end caps 20 and 24 and reducing the overall length of the motor. Thus, first and second end shields 18 and 22 are coupled to first and second stator body ends 38 and 40, respectively.

The above-described motor is a cost-effective and time saving device. The stator assembly includes a protective outer coating on the outer edge of the stator lamination as opposed to having a protective outer shell, thus reducing the amount of time utilized to manufacture the motor. Furthermore, the protective outer coating eliminates the need of a shell to surround the motor. As a result, the protective outer coating facilitates extending a useful life of the motor and reduces manufacturing processes in a cost-effective and a efficient manner.

Exemplary embodiments of stator assemblies are described above in detail. The systems are not limited to the specific embodiments described herein, but rather, components of each assembly may be utilized independently and separately from other components described herein. For example, each stator assembly component can also be used in combination with other rotor assemblies and rotor components.

While the invention has been described in terms of various specific embodiments, those skilled in the art will recognize that the invention can be practiced with modification within the spirit and scope of the claims.

1. A method of forming a protective coating on a stator for an electronically commutated motor (ECM), said method comprising:
providing at least one ECM stator lamination comprising a bore, an inner edge, an outer edge, and an intermediate area extending between the inner edge and the outer edge; and
forming a protective outer coating on the outer edge thereon.

2. A method in accordance with claim 1 wherein said providing at least one stator lamination further comprises a plurality of stacked stator laminations, the outer edges aligned to form a substantially continuous stator body having first and second ends, the inner edges aligned to form a continuous bore.

3. A method in accordance with claim 2 wherein said forming a protective outer coating on the outer edge thereon further comprises forming a protective outer coating on the substantially continuous stator body.

4. A method in accordance with claim 1 wherein the protective outer coating comprises a nonconductive, impermeable paint.

5. A method in accordance with claim 1 wherein the protective outer coating comprises a nonconductive, impermeable resin material.

6. A stator for use in an electronically commutated motor, said stator comprising:
at least one stator lamination comprising a bore, an inner edge, an outer edge, and an intermediate area extending between the inner edge and the outer edge, said outer edge including a protective outer coating thereon.

7. A stator in accordance with claim 6 wherein said at least one stator lamination further comprises a plurality of stacked stator laminations, said outer edges aligned to form a substantially continuous stator body having first and second ends, said inner edges aligned to form a continuous bore.

8. A stator in accordance with claim 7 wherein said inner edge comprises a plurality of slots that extend radially outwardly from said bore.

9. A stator in accordance with claim 8 further comprising a plurality of coils formed from insulated conductive wire inserted into said slots, said coils forming end turn regions positioned at said first and second stator body ends.

10. A stator in accordance with claim 6 wherein said protective outer coating comprises a nonconductive, impermeable paint.

11. A stator in accordance with claim 6 wherein said protective outer coating comprises a nonconductive, impermeable resin material.

12. A stator in accordance with claim 9 wherein said stator further comprises first and second end caps coupled to said first and second stator body ends, respectively.

13. A stator in accordance with claim 12 wherein said stator further comprises first and second end shields coupled to said first and second end caps, respectively.

14. A stator in accordance with claim 9 wherein said stator further comprises first and second end shields coupled to said stator body first and second ends, respectively.

15. A stator in accordance with claim 13 wherein said first and second end caps are fabricated from an electrically insulating plastic material, said first and second end shields are fabricated from aluminum.

16. A stator in accordance with claim 14 wherein said first and second end shields are fabricated from an electrically insulating plastic material.

17. An electronically commutated motor assembly comprising:
a stator comprising a plurality of stacked laminations, each said lamination comprising an inner edge, an outer edge, and an intermediate area extending between the inner edge and the outer edge, said stacked laminations forming a substantially continuous stator body including a first end, a second end, an inner surface, and an outer surface, said inner surface forming a continuous bore extending through said stator body, said outer surface having a protective outer coating thereon;
a first end shield comprising a bearing support having a bearing therein, said first end shield coupled to said first stator body end;
a second end shield comprising a bearing support having a bearing therein, said second end shield coupled to said second stator body end; and
a rotor assembly comprising a rotor shaft, said rotor assembly positioned within said stator bore, said rotor shaft extending through said first and second end shields and rotatably supported by said bearings.

18. An electric motor assembly in accordance with claim 17 wherein each said inner edges comprises a plurality of slots that extend radially outwardly from said bore.

19. An electric motor assembly in accordance with claim 18 wherein said stator further comprises a plurality of coils formed from insulated conductive wire inserted into said slots, said coils forming end turn regions positioned at said first and second stator body ends.

20. An electric motor assembly in accordance with claim 17 wherein said protective outer coating comprises a nonconductive, impermeable paint.

21. An electric motor assembly in accordance with claim 17 wherein said protective outer coating comprises a nonconductive, impermeable resin material.

22. An electric motor assembly in accordance with claim 17 wherein said first and second end shields are fabricated from an electrically insulating plastic material.

23. An electric motor assembly in accordance with claim 19 wherein said stator further comprises a first end cap and a second end cap, said first end cap positioned between said first stator body end and said first end shield, said second end cap positioned between said second stator body end and said second end shield such that said first and second end caps create an electrically insulating barrier between said first end shield and said first stator body end and between said second end shield and said second stator body end, respectively.

24. An electric motor assembly in accordance with claim 23 wherein said first and second end caps are fabricated from an electrically insulating plastic material, said first and second end shields are fabricated from aluminum.
